(19) United States
(12) Patent Application Publication
(10) Pub. No.: US 2016/0162926 A1
(43) Pub. Date: Jun. 9, 2016

(54) Merchandising Promotional Incentives to a Customer at the Point of Sale Through Use of a Dynamic Authetication Code

(71) Applicants: David A. Patterson, Larkspur, CA (US); Joan Ziegler, Tiburon, CA (US)

(72) Inventors: David A. Patterson, Larkspur, CA (US); Joan Ziegler, Tiburon, CA (US)

(21) Appl. No.: 14/563,948

(22) Filed: Dec. 8, 2014

(51) Int. Cl. G06Q 30/02; G06Q 20/40; G06Q 20/34

(52) U.S. Cl. CPC G06Q 30/0226; G06Q 20/34; G06Q 20/405

(57) ABSTRACT

One or more prizes are awarded through use of an electronic card that uses a predictive algorithm residing in its electronic memory to award the prize(s) in response to a winning transaction involving the electronic card and, once a winning transaction occurs, generates a dynamic authentication code (“DAC”) to securely inform an issuing entity about the prize and the winning transaction. The predictive algorithm awards prizes according to prize schedules such that a given prize is won within a given number of transactions (and each such transaction involves sending a DAC to an issuing entity), insures that a gap between two successive winning transactions is between a minimum gap and a maximum gap and each of multiple prizes is won within its own given number of transactions schedule while maintaining the minimum gap and the maximum gap between successive winning transactions, and insures that a given prize can only be awarded a maximum number of times during a lifetime of the card. The predictive algorithm is dependent upon on or more parameters defined by a personalization module that is used to create at least one data file for personalizing the card and a validation software of the issuing entity validates award of the given prize through use of the DAC.

### CROSS REFERENCE TO RELATED APPLICATIONS

This application claims priority from U.S. Ser. No. 61/275,821, filed Sep. 2, 2009, the disclosure of which is specifically incorporated herein by reference, and is a divisional application of U.S. Ser. No. 12/875,008, filed Sep. 2, 2010, the disclosures of both of which are specifically incorporated herein by reference in their entireties.

### FIELD OF THE INVENTION

This application is in the field of merchandising promotional incentives for consumers and, more specifically, merchandising promotional incentives actuated through an electronic card.

### BACKGROUND OF THE INVENTION

It has been a goal for some time to provide technology that supports secure credit card transactions using the existing credit card processing infrastructure. U.S. Pat. No. 7,195,154 proposes use of a Dynamic Authentication Code (“FiteQ DAC”) technology, which integrates an encrypted authentication number into the ISO 7811-2 information transmitted from a dynamic magnetic Track 2 encoder (see ANSI/ISO/IEC 7811-2:1995. Identification Cards—Recording Technique—Part 2: Magnetic Stripe. International Standardization Organization. Dec. 15, 1997, the disclosure of which is specifically incorporated herein by reference).

The FiteQ DAC, when paired with a conventional credit card number, is validated by back-end software (i.e., the FiteQ™ VAULT™ Authorization System [FVAS]) which is integrated with an Issuer's authorization processing system located behind their firewall. The FiteQ technology allows the firmware on the credit card to generate the FiteQ DAC in isolation—no real time wired or wireless connection to the FVAS is required.

FiteQ™ DAC technology is secure because each DAC is valid for only one transaction, and for only the specified cardholder. By utilizing both encryption and random number generation technologies, FiteQ is able to achieve at least a 99.9% level of protection against fraudulent attempts to generate FiteQ DACs.

PromoTeq™ is a new FiteQ™ technology that provides a random chance of winning a promotional prize each time a Card is used. To facilitate the prize process, the card uses the FiteQ DAC technology to transmit secure awarding of promotional prizes at time of purchase while displaying the prize on the Card itself.

Once one becomes aware of such technology, the question becomes: How can it be used? The answer to this question turns in part on the perspective of who is asking the question. In this regard, there are a number of entities in the credit card industry, such as VISA®, MASTER CARD®, AMEX® and DISCOVER®, to name a few of the more common names in the United States today. There are also rewards cards that are issued by banks but through a promotion of another company. For example, mileage credit cards, that are issued by a bank but allow a user to accumulate rewards miles on an airline, have been popular for some time and are known as “co-branded” cards. Such cards will also typically be a VISA® or MASTER CARD®, and they can be used in same fashion and for a variety of uses, much like non-rewards cards. There are also private label cards that are not directly affiliated with a credit card company such as VISA® or MASTER CARD®, and such cards are often only usable at the merchant whose name is associated with the card. Each of these three distinct classes of entities can benefit from the PromoTeq™ technology described herein, although the manner of benefit will vary with the type of entity. Indeed, PromoTee™ technology can be especially useful for the private label card entities. To help understand why this latter category can especially benefit from PromoTeq™ technology, it is first necessary to know a little something about how that sector presently functions in the United States.

Large, multi-store retail merchant chains (“Retailers”) have long offered to consumers the ability to purchase products within these stores by using a retail-branded charge card. These “Private Label” charge cards are valid for purchase within these branded retail stores only, they are not valid for purchases anywhere else. Additionally, these Retailer's Private Label cards are not to be confused with stored-value or “prepaid” cards which might also be offered by these same Retailers. Instead, these Private Label cards behave as traditional charge cards, whereby the cardholder uses this Private Label card in the same way in which they would use a traditional credit card, except that the monthly bill for any purchase would come from a statement prepared and sent to the cardholder from the Retailer, not the issuing bank of the credit card.

However, due to various retail market conditions—such as the increase in debit card usage and the ability to conduct retail purchases via the Internet—the utilization of Private Label cards has been steadily decreasing. Moreover, an additional contributing factor to the decline of purchasing via a Private Label card has to do with the limits of an average consumer's wallet size: the sheer number of cards—financial-related transaction cards as well as other types of cards—which an average consumer possesses compels them to carry in their wallet only the cards which they consider to be essential occupants of their wallet for day-to-day life. More often than not, a Private Label card does not meet this criteria and is consequently not in the consumer's wallet but left dormant in some drawer of the cardholder's home or office instead. This results in the cardholder's usage of a card other than the Retailer's Private Label card when purchasing activity occurs by that same cardholder at that Private Label Retailer's store.

Meanwhile, manufacturers of products sold at retail merchant stores (also known as “Vendors”), have historically maintained a “love/hate” relationship with these Retailers: Vendors are pleased when demand is high because their products may be sold to the Retailer at the price which the Vendor has set. Conversely, Vendors often face difficulty when their inventory is high on a specific product and demand at the Retailer's stores for that specific product is waning. In this very commonplace scenario, in order for the Vendor to successfully persuade the Retailer to purchase additional quantities of the specific product whose inventory is high and whose demand is low (also known as “distressed” product or “distressed” inventory), it is not unusual for the following two-pronged activity to occur:

(1) Price Protection: For the Retailer to purchase additional inventory of the distressed product, the Vendor must first reduce or “mark-down” the price of the distressed product which presently exists in the Retailer's inventory. Then, the Retailer generates a purchase order for a quantity of units to be purchased of this distressed product which is equal to the total dollar amount of the mark-down of the presently existing inventory. Theoretically, there would then be a retail price reduction of the distressed product to help it sell-through.

(2) Market Development Funds (MDF): In an additional effort to maximize sell-through of the distressed product, the Retailer will often negotiate for money from the Vendor to advertise this distressed product, showing off its new, lower retail price. Such advertising activity by the Retailer may include in-store “End-Cap” aisle promotions, ROP (Rate On Print) advertising (e.g. newspaper advertisements or supplements), radio/TV advertising, cash bonuses for Retailers' floor salespersons (known as SPIFFS: Special Performance Incentives for Field Force), etc.

To date, there does not exist a concept which combines the aforementioned scenarios—Retailer's Private Label cards and Vendor's distressed products—to foster increased utilization of a Retailer's Private Label card and improved sell-through of a Vendor's distressed product at the same time. However, PromoTeq™ technology can provide such a concept.

### SUMMARY OF THE INVENTION

The present invention is primarily directed to a process for awarding one or more prizes through use of an electronic card that uses a predictive algorithm residing in its electronic memory to award the prize(s) in response to a winning transaction involving the electronic card and, once a winning transaction occurs, generates a dynamic authentication code (“DAC”) to securely inform an issuing entity about the prize and the winning transaction.

In a first separate group of aspects of the present invention, the predictive algorithm awards prizes according to prize schedules such that a given prize is won within a given number of transactions (and each such transaction involves sending a DAC to an issuing entity), insures that a gap between two successive winning transactions is between a minimum gap and a maximum gap and each of multiple prizes is won within its own given number of transactions schedule while maintaining the minimum gap and the maximum gap between successive winning transactions, and insures that a given prize can only be awarded a maximum number of times during a lifetime of the card. The predictive algorithm is dependent upon on or more parameters defined by a personalization module that is used to create at least one data file for personalizing the card and a validation software of the issuing entity validates award of the given prize through use of the DAC.

In a second, separate group of aspects of the present invention, the card (e.g., a financial transaction card) displays a prize state for a winning transaction and the prize (e g., an entry to a lottery) can be awarded contemporaneously with the display of the prize state or awarded by the issuing entity.

Accordingly, it is a primary object of the present invention to provide technology that merchandises a reward to a cardholder at a point of sale.

This and further objects and advantages will be apparent to those skilled in the art in connection with the drawings and the detailed description of the preferred embodiment set forth below.

### BRIEF DESCRIPTION OF THE DRAWING

FIG. 1 is a diagram of the backside of a card with a depiction of three prize levels that might be offered on a card in accordance with a preferred embodiment of the present invention.

### DETAILED DESCRIPTION OF THE INVENTION

PromoTeq provides to a Cardholder a chance to win a prize every time a Card is used. In the context of this invention, a Card is not limited to the physical form factor of a conventional credit, debit, or charge card (i.e., a conventional CR80 card), but can be manifested in other physical form factors. (E.g. key fob, mobile phone, PDA, etc.) Moreover, the platform by which PromoTeq may exist is not limited to a magnetic stripe reader transaction. The information communicated in the transaction may transferred by means of a magnetic stripe or other means such as, but not limited to, a contact chip (EMV), contactless chip (radio frequency), infrared, Bluetooth, and other similar means.

In an especially preferred embodiment, PromoTeq uses pseudo random number generation (PRNG) to determine if a prize—and which prize—has been won, uses Light Emitting Diodes (LEDs) or other types of displays (e.g., an LCD or other technology providing an alphanumeric display of information) to display the prize state on the Card, and uses a DAC to securely inform the Issuer about the prize. Although it is especially preferred that the FiteQ DAC be used with PromoTeq, the invention is not so limited, and the invention can be used with any technology that uses a dynamic authentication code; however, for ease of reference, the invention will hereinafter be described by reference to the FiteQ DAC.

In an especially preferred embodiment, PromoTeq supports three distinct prizes (P1, P2, and P3), and awards them on three independent schedules such that each prize Pn is won exactly once every Xn transactions, respectively (i.e., X2, and X3). Although one skilled in the art will immediately recognize that either fewer than three or greater than three distinct prizes can be offered, the following description will focus on just three levels, recognizing that the same principles discussed herein can easily be adapted to any such other use. Accordingly, in the especially preferred embodiment discussed hereinafter, PromoTeq allows specification of the maximum number of times that a given prize can be awarded during the lifetime of a given Card (M1, M2, and M3). PromoTeq also allows specification of the minimum and maximum gaps (i.e., number of non-winning transactions) that may occur between successive winning transactions (Gmin and Gmax).

A PromoTeq “transaction” is defined as turning on the card, swiping it one or more times, and then turning off the card. The Card must be swiped to display (and consume) the prize, and no prize can be wasted by merely turning the Card on and off again. Each transaction is sequentially numbered in the range [0,9999]. It is especially preferred that the DAC be transmitted to an issuer of the Card during each transaction so that multiple swipes cannot be used for one financial transaction. To avoid transactions being wasted through multiple swipes (either intentionally or due to occasional readability problems), the Card can be programmed so as to require a certain minimum time period lapse required between multiple swipes for such multiple swipes to be counted as sequential transactions.

PromoTeq deploys a predictive algorithm which ensures that each of the prizes are won at the specified frequencies, and that Mn, Gmin and Gmax are all maintained. This algorithm is dependent on PRNG parameters defined by the FiteQ Personalization Module (FPF), which is software that is used to create the data files for personalizing the Card surface (e.g., embossing, prize names, etc.) and smartchip (e.g., cardholder account data). The FPF selects different parameters for each Card, and supplies these parameters to both the Card and FVAS.

When a winning transaction occurs, the Card generates a FiteQ DAC such that the Counter Block used is the same as the winning transaction number. The actual prize won is explicitly coded inside of the FiteQ DAC's Transaction Information Digit (TID). When the FVAS receives a FiteQ DAC, it duplicates the PromoTeq algorithmic calculation to validate the prize.

An especially preferred PromoTeq Algorithm will now be disclosed that is suited for use in a Card in which information is communicated in the transaction and transferred by means of a magnetic stripe. The PromoTeq algorithm requires the FPF parameters shown in Table 1, and requires the data storage shown in Table 2.

TABLE 1
PromoTeq Algorithm: Input Parameters

| Parameter Name | Parameter Symbol |
|---|---|
| PRNG seeds | Sx0, Sx1, Sx2 |
| Transaction counter | TC |
| Prize periods | T1, T2, T3 |
| Maximum number of times each | Ml, M2, M3 |
| prize can be awarded | |
| Minimum gap between prizes | Gmin |
| Maximum gap between prizes | Gmax |
| Starting counter | SC |
| Ending counter | EC |

TABLE 2
PromoTeq Algorithm: Working Storage

| Parameter Name | Parameter Symbol |
|---|---|
| Next winning transaction | W1, W2, W3 |
| Start counter of next prize period | SC 1, SC 2, SC 3 |
| Number of prizes already awarded | A1, A2, A3 |

When the Promoleq card is first initialized, it calculates at which transaction each of the three prizes will next be won. This algorithm is shown in Table 3.

TABLE 3
PromoTeq Algorithm: Initialiation

| Step | Meaning | Logic |
|---|---|---|
| 1.1 | Initialize number of | A1 = 0; |
| | prizes already to 0 | A2 = 0; |
| | | A3 = 0; |
| 1.2 | Initialize next winning | W1 = SC − 1; |
| | transaction to value | W2 = SC − 1; |
| | guaranteed to never | W3 = SC − 1; |
| | occur | |
| 1.3 | Initialize counter of | SC1 = SC + T1; |
| | start of next prized | |
| | period for Prize 1 | |
| 1.4 | Initialize counter of | SC2 = SC + T2; |
| | start of next prize | |
| | period for Prize 2 | |
| 1.5 | Initialize counter of | SC3 = SC + T3; |
| | start of next prize | |
| | period for Prize 3 | |
| 1.6 | If Prize 1 maximum | If (M1 > A2) |
| | is not 0, calculate the | W1 = SC + |
| | next winning | (int) (((float)(nextPRN( ) − 1)/32361) * |
| | transaction for Prize | T1); |
| | 1 | |
| 1.7 | If Prize 2 maximum is | If (m2 > A2){ |
| | not 0, calculate the | done = false; |
| | next winning | while (!done){ |
| | transaction for Prize | temp = SC + |
| | 2, ensuring that Gmin | (int) (((float)(nextPRN( ) − 1)/32361) * |
| | is not exceeded with | T2); |
| | respect to Prize 1 | If (Gmin < abs(temp − W1)) |
| | | done = true |
| | | W2 = temp |
| | | } |
| | | } |
| 1.8 | If Prize 3 maximum is | If (M3 > A3){ |
| | not 0, calculate the | done = false; |
| | next winning | while (!done){ |
| | transaction for Prize | temp = SC + |
| | 3, ensuring that Gmin | (int) (((float)(nextPRN( ) − 1)/32361) * |
| | is not exceeded with | T3); |
| | respect to both Prize | If ((Gmin < abs(temp − W1)) && |
| | 1 and 2 | (Gmin < abs(temp − W2))) |
| | | done = true; |
| | | W3 = temp; |
| | | } |
| | | } |

At the time of each transaction, the Card checks the current Transaction Counter against the values Wi, W2, W3 to determine if the current transaction is a winning transaction. If so, the Card uses the algorithm shown in Table 4 to calculate the next winning transaction for the prize won during the current transaction, assuming that Prize 1 has been won.

TABLE 4
PromoTeq Algorithm: Winning Prize 1

| Step | Meaning | Logic |
|---|---|---|
| 2.1 | Increment the prize | A1 = A− + 1; |
| | counter | |
| 2.2 | If Prize 1 has not | If (M1 > A1){ |
| | yet been exceeded, | Done = false; |
| | calculate the next | While (1done) { |
| | winning transaction | Temp = SC1 + |
| | for Prize 1, ensuring | (int) (((float)(nextPRN( ) − 1)/ |
| | that Gmin and Gmax | 32361) * T); |
| | is not exceeded with | If ((Gmin < abs(temp − W1)) && |
| | respect to the current | (Gmin < abs(temp − W2)) && |
| | win of Prize 1, as | (Gmin < abs(temp − W3))) |
| | well as the respect to | { |
| | the next wins of both | If ((Gmax + 1 >= abs(tempW1)) \|\| |
| | Prize 2 and Prize 3 | (Gmax + 1 >= abs(temp − W2)) \|\| |
| | | (Gmax + 1 >= abs(temp − W − 3))) |
| | | Done = true; |
| | | } |
| | | W1 = temp |
| | | SC1 = SC1 + T1; |
| | | } |
| | | } |

The actual PRV sequence, which determines the prize sequence, is different for every Card. This accomplished by assigning each card a unique set of PRNG seeds, as described below in the discussion of Pseudo Random Number Generation

PromoTeq encodes the prize code into the Transaction Identification Digit (TID) of the FiteQ DAC by adding the Prize code value (0, 1, 2, 3) to the Subaccount Identifier (SID), where Prize code 0 means no prize was won. This allows for a total of 20,000 transactions per account. Each Card will be designed to last for an average of 3 transactions per day for three years, for a total of 3285 transactions. To accommodate this, each Card will be assigned a range of 3300 FiteQ DACs. By using SID values of 0 and 4, up to 6 PromoTeq Cards may be issued for a single account, where each FiteQ DAC is guaranteed to be unique.

FVAS is used to validate a PromoTeq FiteQ DAC and report the prize that was won. It can be used online as part of authorization processing, or can be used offline in a batch processing mode. It accepts as input the Cardholder account number and the FiteQ DAC, which can be used only once. FVAS validates the FiteQ DAC to insure that fraudulent prizes are not awarded and that prizes are not duplicated. It validates the prize reported to have been won in the TID by extracting the FiteQ DAC Subaccount Identifier, extracting the FiteQ DAC Counter Block, and then duplicating the calculations performed by the Card. Alternatively, the FVAS may precalculate all winning transaction numbers, and then look them up in the database.

It is especially preferred that every PromoTeq Card utilizes the same PRNG described in P. L'Ecuyer, “Efficient and Portable Combined Random Number Generators”, Communications of the ACM, 31(6)142-749, 774, 1988 and P. L'Ecuyer, “A Portable Random Number Generator for 16-bit Computers”, Modeling and Simulation on Microcomputers, SCS, January 1987, pp. 45-49, the disclosures of which are specifically incorporated herein by reference. However, each Card has a different initial seed, and thus uses a different part of the PRNG sequence. Since the PRNG has an overall period of 1012, there is ample room for each Card to have its own non-repeating subsequence of up to 100,000 values (which can also be spread over multiple Cards with the same account).

Base Formulas. The PRNG is divided into two parts: seed generation (Table 5) and value calculation (Table 6). In these formulas (expressed using C code fragments), the set (Sx0, Sx1, Sx2) is a triplet of five-digit values in the range ([1,32362], [1, 31726], [1,31656]), and represents the seed in the xth location in the sequence. Z is interim storage for the pseudo random number, and PRV[x] indicates the pseudo random value in the xth location in the sequence. Note that for the practical usage of this algorithm, “x” corresponds to the current Counter value. For each transaction, Table 5 generates the seed (based on the previous seed) and Table 6 generates the PRV value, which is in the range [1, 32362].

TABLE 5
PRNG Seed Generation

Sₓ⁰ = (Sₓ₋₁⁰ * 157) mod 32363
Sₓ¹ = (Sₓ₋₁¹ * 146) mod 31727
Sₓ² = (Sₓ_{_{—}}₁² * 142) mod 31657

TABLE 6
PRNG Value Calculation

Z = Sₓ⁰⁻ Sₓ¹;
if (Z > 706) Z = Z − 32362;
Z = Z + Sx²;
if (Z < 1) Z = Z + 32362;
PRV[x] = Z

In all cases, the initial PRNG seed (which generates value 0 in the PRNG sequence) is pre-assigned to the Card. Additionally, the most recently used seed is stored in EEPROM. Thus, when a PRV must be generated, the Card runs through both Tables 5 and 6 exactly once, and then updates the seed storage in EEPROM.

The PRNG seeds and value all evolve independently and form an approximate uniform distribution. Through the use of simulations, FiteQ has verified that the PRNG implementation does indeed form an approximate uniform distribution centered on the mean of the interval for each of the seeds and the value, within a 99% confidence interval.

One way in which PromoTeq™ technology can be used is in a loyalty program in which relatively low-value loyalty program prizes are used as a promotional incentive at the Point of Sale. The PromoTeq Loyalty card displays the prize at the time of purchase and transmits the prize code to the FiteQ VAULT installation at the Issuer authorization processing center at time of transaction authorization. The FiteQ VAULT notifies the Issuer of the prizes won on a daily basis. Prize redemption is handled entirely by the Issuer.

The following description provides a system-level specification of one especially preferred PromoTeq Loyalty product using the form factor of a magnetic strip card.

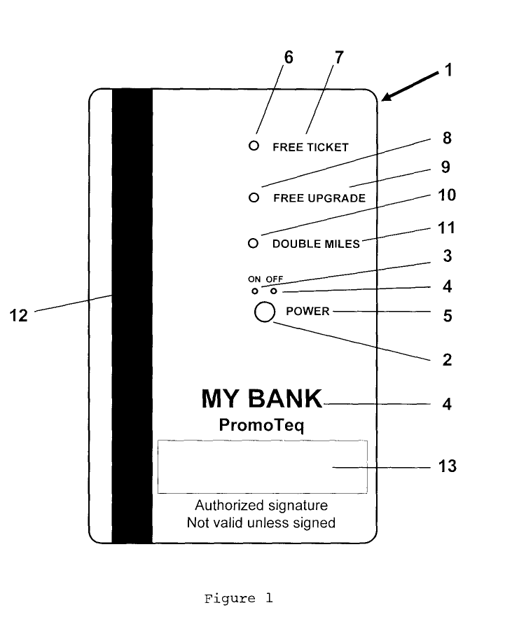

Concept Overview. The PromoTeq Loyalty card is personalized with one Primary Account Number and three potential prizes. A description of each prize (7, 9 and 11) is printed next to an LED (6, 8 and 10) on the back of Card 1, as shown in FIG. 1. Also present on the back of Card 1 is a power button 2 (identified by printing 5) with a green LED 3 and a “Shop again to win” red LED 4 which may also have a shop again label (not shown) next to it, as well as a magnetic stripe 12, signature strip 13 and labeling 14. The Cardholder must turn on the card to perform a transaction. The card displays a “roulette wheel” by blinking each of the prize LEDs in succession for several “spins”, and then waits for the Cardholder to perform the transaction. Once the transaction is complete, the card blinks either the LED of the prize won or the “Shop again to win” LED if no prize was won. Both the prize code and the FiteQ DAC are transmitted to the FiteQ VAULT along with the authorization request and when the FiteQ DAC is validated, the VAULT logs the prize. The VAULT notifies the Issuer of the prizes won on a daily basis. Prize redemption is handled entirely by the Issuer. An example of a possible PromoTeq Loyalty prizes might be an award of double or triple miles on a purchase using an airline mileage reward card.

The PromoTeq Loyalty card comprises three main components: the PromoTeq card, the FiteQ Personalization Module (FPF) and the FiteQ VAULT Authorization System (FVAS).

The PromoTeq Loyalty card is the physical device used by the Cardholder to conduct transactions and receive loyalty promotion prizes. It does not necessarily have to be in the form factor of a standard credit card; it could be shaped like a fob or some other device, or even be a smart phone. If the card is in the form factor of a standard credit card, then the front of the card will look like a standard credit card and the back of the card will look similar to the image shown in FIG. 1. The exact card appearance (i.e., card graphics, embossing information, LED colors, signature panel placement, button/LED/prize names and printed text) are subject to final agreement with an Issuer of the card.

The PromoTeq Loyalty card operates as follows: The Cardholder turns on the card by pressing the “On/Off” button. The card displays a “roulette wheel” or “wheel of chance” by blinking each of the prize LEDs in succession, once every second, for a total of three cycles (i.e., 1-2-3-1-2-3-1-2-3). After the roulette wheel completes, the card blinks the “On/Off’ LED once every three seconds until either the transaction is performed, the card is manually turned off or the card automatically turns off. Default automatic turnoff time is 5 minutes after turn on or last swipe, although this value may be changed by the Issuer. After the Cardholder performs the transaction, the card indicates which prize was won by blinking the associated prize LED 1, 2 or 3. If no prize was won, the card blinks the “Shop Again to Win” LED. The card creates a FiteQ DAC (which is valid for only one use), encodes the prize code information into the FiteQ DAC if a prize was won, and then transmits the DAC/prize code in the discretionary data area of Track 1 and/or Track 2.

The FiteQ Personalization Module (FPF) is software that is used to create the data files for personalizing the card surface (e.g., embossing, prize names) and smartchip (e.g., Cardholder account data). FPF can be deployed either at the Issuer or at a FiteQ-certified Service Bureau. FPF is configured to support multiple Cardholder Segments, each of which contains the information listed below. The Issuer may define these Segments however they choose (e.g., by account demographics/profiles (high transactors), by zip code, etc.).

Segment Number. This number uniquely identifies the segment, and is used in the FPF input file to associate an individual Cardholder with a Segment.

Expected Number of Transactions per Month. This specifies the average number of transactions per month expected to be performed by a Cardholder in this Segment. This value is used, together with the Expected Award Frequency, to determine when to award the prize.

Prize Expected Award Frequency. This field is present three times, one for each of Prize 1, 2 and 3. The actual number may be different for each Prize. The number specifies the number of months during which a Cardholder in this Segment will win the Prize exactly one time, assuming they perform the Expected Number of Transactions per Month. The actual winning transaction is calculated and distributed within the parameters set by the Issuer. The actual award frequency will vary based upon the Cardholder's actual number of transactions per month: if they perform more transactions per month than specified in the Expected Number of Transactions Per Month value (above), then they will win prizes more often.

Prize Maximum Awards. This field is present three times, one for each of Prizes 1, 2 and 3. The actual number may be different for each Prize. This number specifies the maximum number of times that the Prize will be awarded per Card.

Minimum Prize Gap. This number specifies the minimum number of non-winning transactions that must occur between the occurrence of any two winning transactions.

Maximum Prize Gap. This number specifies the maximum number of non-winning transactions that may occur between the occurrence of any two winning transactions.

Prize Labels. This field is present three times, one for each of Prize 1, 2 and 3. The actual label may be different for each Prize. The label is the text to be printed for next to the Prize LED. Prize Labels are printed at the point of personalization. Prize Labels can vary by Segment.

Prize Descriptors. This field is present three times, one for each of Prizes 1, 2 and 3. The actual descriptor must be different for each Prize. The descriptor is the text or number that will be provided in the FVAS daily prize results report, and which will be used by the Issuer to determine the actual prize category. Prize descriptors can vary by Segment.

The FPF accepts as input a data file created by the Issuer that describes card information. This data file contains, at a minimum, the following information for each card:

Primary Account Number

Cardholder name

Card Expiration Date

Three or four-digit card validation code

Additional embossed or printed information

Track 1 and Track 2 Data. This data is what is normally encoded on Track 1 and Track 2 of the magnetic stripe. The FiteQ Card modifies this data by inserting a FiteQ DAC into characters 57 through 65 of Track 1 and 29 through 37 of Track 2.

Cardholder Segment Number. This number identifies the segment to which this Account belongs, which in turn will be used to determine the actual prize distribution.

Prize identification numbers. This field is present three times, one for each of Prizes 1, 2 and 3. The actual identification number may be different for each Prize. This number represents the identification number associated with the Cardholder for the specified prize (e.g., frequent flyer account number). This number will be provided in the FVAS daily prize results report as part of the identification of the prize won by the Cardholder.

FPF generates data files which are used to personalize individual cards using a DataCard 7000/9000 series personalization system that is configured with the FiteQ Smart Card Personalization System (F-SCPM). The DataCard/F-SCPM can reside at the Issuer or at any FiteQ Certified Personalization Service Bureau.

The FiteQ VAULT Authorization System (FVAS) is software that is used to validate FiteQ DACs and to determine if a PromoTeq prize has been won. This software can run either on a standalone computer or can be integrated in with the Issuer authorization processing software for real-time FiteQ DAC validation. If the FiteQ DAC security feature for transaction validation is not implemented, and only the prize award process is required, this can be accomplished in batch mode (i.e., not required to be integrated into the Issuer's real-time transaction authorization process).

FVAS is configured by importing Cardholder Account data from the FiteQ FPF.

When the Issuer authorization processing software receives an authorization request, the FiteQ DAC will be included in the Track data received as part of that request. The entire Track data “packet” must be passed to FVAS in real-time if the FiteQ DAC is used for transaction validation. FVAS validates the FiteQ DAC for the Account number and ensures that it has not already been used. For real-time DAC validation, FVAS returns a response code to the Issuer authorization processing software to indicate whether or not the FiteQ DAC was valid. The final determination as to whether or not to allow the transaction is made by the Issuer. FVAS also logs this information to an audit trail, which can later be accessed to generate a report.

Prize Validation. When FVAS receives a DAC for validation, it additionally determines if the FiteQ DAC contains an encoded prize code. FVAS must also be provided the transaction amount, for use in prizes which are related to the transaction amount (e.g., double miles).

Prize Reporting. For real-time FiteQ DAC validation, FVAS returns a response code to the Issuer authorization processing software to indicate which prize (if any) was won, so that the prize redemption can optionally be handled by downstream Issuer software. Whether or not real-time FiteQ DAC validation is performed, FVAS logs the FiteQ DAC validation and prize validation to an audit trail, and can be instructed to generate a daily report of all prizes won. This report is used by the Issuer to handle prize redemption and Cardholder notification.

Prize Determination. PromoTeq deploys a predictive algorithm which supports distribution requirements by market segment to determine when a prize is won. The prize frequency is specified by the FPF Cardholder Segment with which a card is associated. FPF ensures that each of the prizes is won at the specified frequencies, and that the minimum and maximum gaps between prizes are maintained.

Even though every card in a Cardholder Segment has the same prize frequency, the actual transactions in which prizes are won differs among cards.

The prize sequence is calculated and predictable, and is governed by parameters set by the Issuer and generated by the FPF. These same parameters are both downloaded to a card and exported to FVAS. This enables FVAS to validate the prize information calculated in a card and encoded in a FiteQ DAC.

Another way in which Promoleq™ technology can be used is in a loyalty program which merchandises a Cardholder's automatic entry into a lottery for a relatively high-value prize with each transaction at the Point of Sale. PromoTeq Lottery is the physical device used by the Cardholder to conduct transactions and enter the promotional lotteries. It does not necessarily have to be in the form factor of a conventional CR-80 card; it could be shaped like a fob or some other device. However, to simplify the language used in this document, PromoTeq Lottery will be referred to hereinafter as a card, and the person to whom it is issued will be referred to as the Cardholder.

The PromoTeq Lottery card is personalized with one Primary Account Number and three lotteries. A description of each lottery is printed next to an LED on the back of the card. Also present on the back of the card is a power button, a green “On” LED, a red “Off’ LED and a “Shop Again to Enter” label with an orange LED.

The Cardholder must turn on the card to perform a transaction. The card waits for the Cardholder to perform the transaction, and then displays a “roulette wheel” by blinking each of the lottery LEDs in succession for several “spins”, slows, and finally stops on the lottery entered or the “Shop again to enter” LED if no lottery was entered.

Both the lottery code and the FiteQ DAC are transmitted to the FiteQ VAULT along with the authorization request and when the FiteQ DAC is validated, the VAULT logs the lottery entry. The VAULT notifies the Issuer of the lotteries entered on a daily basis.

The lottery itself, including all aspects of handling entries, picking winners, notifying winners and awarding prizes, is entirely operated by the Issuer (or a third party), not by Fite( ) or the Fite( ) VAULT. The Issuer may also be required by law to allow lottery entries by a method not requiring a purchase (e.g., by sending an email or mailing a letter).

Some representative examples of PromoTeq Lottery prizes are as follows: 100% percent cash back on this transaction, Double cash back on this transaction, 10-times points on this transaction and double points on this transaction.

The PromoTeq Lottery comprises three main components: the PromoTeq Lottery card, the FiteQ Personalization Module (FPF) and the FiteQ VAULT Authorization System (FVAS).

The PromoTeq Lottery card operates as follows: The Cardholder turns on the card by pressing the “On” button. In preparation for the transaction, the card randomly selects a lottery to be entered and then creates a DAC (which is valid for only one use), encoding the lottery code into the DAC. The card blinks the green “On” LED once every three seconds until either the transaction is performed, the card is manually turned off or the card automatically turns off. Default automatic turnoff time is 3 minutes after turn on or last swipe, although this value may be changed by the Issuer. When the Cardholder performs the transaction, the card transmits the FiteQ DAC/lottery code in the Track 2 discretionary data area. The FiteQ DAC/lottery code are transmitted to the FiteQ VAULT along with the authorization request and when the FiteQ DAC is validated, the VAULT logs the lottery entry. After the Cardholder performs the transaction, the card displays a “roulette wheel” by blinking each of the lottery LEDs and the “Shop Again to Win” LED in succession, stopping on the LED associated with the lottery entered (or “Shop Again to Enter”), and then blinks the LED of the lottery entered three additional times. The VAULT notifies the Issuer of the lotteries entered on a daily basis.

The lottery itself, including all aspects of handling entries, picking winners, notifying winners and awarding prizes, is entirely operated by the Issuer (or a third party), not by FiteQ or the FiteQ VAULT. The Issuer may also be required by law to allow lottery entries by a method not requiring a purchase (e.g., by sending an email or mailing a letter).

The FiteQ Personalization Module (FPF) is software that is used to create the data files for personalizing the card surface (e.g., embossing, prize names) and secure chip (e.g., Cardholder account data). FPF can be deployed either at the Issuer or at a FiteQ-certified Service Bureau.

FPF is configured to support multiple Cardholder Segments, each of which contains the information listed below. The Issuer may define these Segments however they choose (e.g., by account demographics/profiles (high transactors), credit line, zip code, etc.).

Segment Number. This number uniquely identifies the segment, and is used in the FPF input file to associate an individual Cardholder with a Segment.

Lottery Labels. This field is present three times, one for each of Lottery 1, 2 and 3. The actual label should be different for each Lottery. The label is the text to be printed for next to the Lottery LED. Lottery Labels are printed at the time of personalization. Lottery Labels can vary by Segment.

Lottery Descriptors. This field is present three times, one for each of Lottery 1, 2 and 3. The actual descriptor must be different for each Lottery. The descriptor is the text or number that will be provided in the FVAS daily lottery entry results report, and which will be used by the Issuer to uniquely identify the lottery. Lottery descriptors can vary by Segment.

Lottery Probabilities. This field is present three times, one for each of Lottery 1, 2 and 3. The actual field value may be different for each Lottery. The number specifies the probability of the Cardholder being entered into this lottery for any given transaction. The sum total of the three values for Lottery 1 2 and 3 must add up to less than or equal to 100.0. The difference between 100.0 and the sum total of the three values for Lottery 1, 2 and 3 will be the probability of the Cardholder not being entered into any lottery for any given transaction. The actual lottery entered is randomly selected by the card.

Card Configuration. The FPF accepts as input a data file created by the Issuer that describes card information. This data file contains, at a minimum, the following information for each card:

Primary Account Number

Cardholder name

Card Expiration Date

Three or four-digit card validation code

Additional embossed or printed information

Track 1 and Track 2 Data. This data is what is normally encoded on Track 1 and Track 2 of the magnetic stripe. The FiteQ card modifies this data by inserting a DAC into characters 57 through 65 of Track 1 and 29 through 37 of Track 2.

Cardholder Segment Number. This number identifies the segment to which this Account belongs, which in turn will be used to determine the actual lottery entry handling.

Cardholder Lottery identification numbers. This field is present three times, one for each of Lottery 1, 2 and 3. The actual identification number may be different for each Lottery. This number represents the identification number associated with the Cardholder for the specified lottery, assuming that the Cardholder will not necessarily by identified by their PAN. This number will be provided in the FVAS daily lottery entry results report as part of the identification of the lottery entered by the Cardholder.

Card Personalization. FPF generates data files which are used to personalize individual cards using a DataCard 7000/9000 series personalization system that is configured with the FiteQ Smart Card Personalization System (FSCPM). The DataCard/F-SCPM can reside at the Issuer or at any FiteQ Certified Personalization Service Bureau.

The FiteQ VAULT Authorization System (FVAS) is software that is used to validate FiteQ DACs and to determine if a PromoTeq lottery has been entered. This software can run either on a standalone computer or can be integrated in with the Issuer authorization processing software for real-time DAC validation. If the FiteQ DAC security feature for transaction validation is not implemented, and only the lottery entry process is required, this can be accomplished in batch mode (i.e., not required to be integrated into the Issuer's real-time transaction authorization process).

Cardholder Account Configuration. FVAS is configured by importing Cardholder Account data from the FiteQ FPF.

FiteQ DAC Authorization Validation for Cardholder security. When the Issuer authorization processing software receives an authorization request, the FiteQ DAC will be included in the Track data received as part of that request. The entire Track data “packet” must be passed to FVAS in real-time if the FiteQ DAC is used for transaction validation. FVAS validates the FiteQ DAC for the Account number and ensures that is has not already been used.

For real-time FiteQ DAC validation, FVAS returns a response code to the Issuer authorization processing software to indicate whether or not the FiteQ DAC was valid. The final determination as to whether or not to allow the transaction is made by the Issuer. FVAS also logs this information to an audit trail, which can later be accessed to generate a report.

Prize Validation. When FVAS receives a FiteQ DAC for validation, it additionally determines if the FiteQ DAC contains an encoded lottery code.

Prize Reporting. For real-time DAC validation, FVAS returns a response code to the Issuer authorization processing software to indicate which lottery (if any) was entered, so that the lottery entries can optionally be handled by downstream Issuer software.

Whether or not real-time FiteQ DAC validation is performed, FVAS logs the FiteQ DAC validation and lottery entry validation to an audit trail, and can be instructed to generate a daily report of all lotteries entered. This report is used by the Issuer to handle lottery entries and Cardholder notification.

Stand In Processing. If a transaction is authorized by Stand In Processing (STIP), then the FiteQ DAC and lottery code generated and displayed by the PromoTeq card will never reach the FiteQ VAULT. In this case, it must be the responsibility of the Cardholder to notify the Issuer of the problem in order for it to be resolved.

The Cardholder is not normally notified that a transaction has been authorized by STIP, and so needs to verify that a lottery has been entered by contacting the Issuer to verify that the lottery entry has been properly recorded. The Issuer may choose to provide a website with this information, and update it on a daily basis using the daily lottery entry report generated by FVAS.

Since the lottery entries are handled entirely by the card, FVAS does not have the information to determine if a lottery entry should have been received. However, since laws governing lotteries generally require that no purchase is required to enter the lottery, the Issuer may choose to allow the Cardholder to solve the problem by manually entering the lottery.

Another way in which PromoTeq™ technology can be used is in an electronic version of a conventional Retailer's Private Label card. The electronic Private Label card or device would include informational feedback to the consumer at the POS at the moment of transaction in the form of light-emitting diode (LED's) lights and/or Liquid Crystal Display (LCD's), the latter providing alpha-numeric informational feedback to the consumer. In an LED, LCD, or combined LED+LCD version, the informational feedback to the consumer would be that of a reward, reflecting their usage of a Retailer's electronic Private Label card or device. The following is an example of the consumer experience at the Retailer's POS when using a version of the electronic Private Label card or device which possesses LED's.

This electronic Private Label card or device would contain an ON/OFF button and, for example, four LED's. Each of the following terms would have their own individual LED placed next to them: “PLATINUM”, “GOLD”, SILVER”, “TRY AGAIN LATER”. Upon using this electronic Private Label card or device at the POS—at the exact moment of the transaction—these LED's would commence to turn on-and-off in a sequential flickering style, similar to that of a “Wheel of Fortune”. Once this rotating flickering of the LED's has concluded—again, emulating a Wheel of Fortune—one of these LED's would remain on. Should the LED which remains on be an LED other than “TRY AGAIN LATER”, the consumer has just been notified that they have won a reward due to their usage of that Retailer's electronic Private Label card or device. When this occurs, the consumer would locate the Retailer's large in-store display (presumably near the cashier area) which explains to the consumer the nature of the reward, as follows: on the in-store display, each remaining term—“PLATINUM”, “GOLD”, “SILVER” would represent specific reward levels to the consumer, and each term would have a specific corresponding Vendor name associated with it. Next to the term, the Vendor would explain the nature of the reward—presumably representing some type of discount to distressed product existing in the Retailer's inventory.

For the Retailer, based on conditions of various Vendor's distressed products in inventory, there is opportunity for them to periodically modify the Vendor designates to each of the terms. For example, Vendor ‘A’ may host the PLATINUM spot for a week period, Vendor ‘B’ may host the GOLD spot for a month period, while Vendor ‘C’ may host the SILVER spot for an entire season. By keeping the terms generic—“PLATINUM”, GOLD”, and “SILVER”—the Retailer may have Vendors be swapped in-and-out with ease, based on the Retailer's discretion.

For the consumer, for the Retailer, and for the Vendor, this is a novel win-win-win invention:

Consumer: by the mere usage of the Retailer's electronic Private Label card or device, they have the potential to have a reward dispensed to them at the precise moment of exhibiting their loyalty to that Retailer (at the POS) and have this reward be presented to them on the Retailer's electronic Private Label card or device, allowing them to know that they are granted this opportunity of winning a reward only by using that Retailer's electronic Private Label card or device.

Retailer: by addressing the appeal which promotional loyalty programs have with consumers and by recognizing that this promotional loyalty program is exclusively tied to their usage of that Retailer's electronic Private Label card or device, the Retailer should definitely experience an increase in usage of their Private Label card or devices. Additionally, this is a new and improved method of creatively and meaningfully utilizing Vendor's MDF (by offering a new and exciting means of advertising), as well as accelerating the sell-through of distressed inventory.

Vendor: in addition to some of the benefits which the Retailer experiences—new and improved method of MDF spending, new exciting means of advertising, accelerating the sell-through of distressed inventory—this concept could warrant major improvements to Vendor's distressed inventory when applied to multi-Retail chains.

While the invention has been described herein with reference to a preferred embodiment, this embodiment has been presented by way of example only, and not to limit the scope of the invention. For example, the details of construction of a Card, such as a conventional CR-80 card, have not been provided herein. However, if one wanted to learn how to manufacture such a card, one could look to U.S. patent application Ser. No. 11/413,595, filed Apr. 27, 2006, the disclosure of which is specifically incorporated herein by reference. Also, additional embodiments of the present invention will be obvious to those skilled in the art having the benefit of this detailed description. Further modifications are also possible in alternative embodiments without departing from the inventive concept.

Accordingly, it will be apparent to those skilled in the art that still further changes and modifications in the actual concepts described herein can readily be made without departing from the spirit and scope of the disclosed inventions.

What is claimed is:

1. A method for awarding a prize through use of an electronic card, comprising the steps of:
(1) turning the electronic card on for a given transaction;
(2) using a predictive algorithm stored in the electronic card to determine whether the given transaction is or is not a winning transaction and, if the given transaction is a winning transaction, which of at least two different prizes from a plurality of prizes has been selected as a winning prize for the winning transaction, and then encoding a prize code for the winning prize in a unique dynamic authentication code (“DAC”) that is generated by the electronic card;
(3) transferring the DAC to a software authorization processing system with a transaction data packet for the given transaction to validate the given transaction through use of the DAC and the transaction data packet;
(4) providing a visual indication on the electronic card of which of the at least two different prizes is the winning prize when the given transaction is the winning transaction; and
(5) repeating steps (1) to (4) until at least one given transaction is the winning transaction;
wherein the DAC is uniquely generated for each given transaction.

2. The method of claim 1, comprising the additional step of validating each given transaction by the software authorization processing system.

3. The method of claim 1, wherein the software authorization processing system validates the winning prize for the winning transaction through use of the prize code encoded in the DAC.

4. The method of claim 3, wherein the DAC is not transferred to the software authorization processing system through use of a magnetic stripe reader.

5. The method of claim 3, wherein the DAC is transferred to the software authorization processing system through use of a magnetic stripe reader.

6. The method of claim 5, wherein the predictive algorithm supports three distinct prizes (P1, P2 and P3) and awards them on three independent schedules such that each prize Pn is won exactly once every Xn transactions.

7. The method of claim 6, wherein each of the Xn transactions generates a new DAC.

8. The method of claim 7 wherein the predictive algorithm insures that a gap between two successive winning transactions is between a minimum gap and a maximum gap.

9. The method of claim 1, comprising the additional step of:
offering the winning prize to an entity using the electronic card at a point of purchase at which the DAC was received for the winning transaction; and
correlating the winning prize to a distressed item of merchandise.

10. The method of claim 9, comprising the additional step of receiving a promotional consideration from a third party for correlating the winning prize to the distressed item of merchandise.

11. The method of claim 10 wherein the electronic card is enrolled in a retailer private label card program.
